(19) United States
(12) Patent Application Publication
(10) Pub. No.: US 2014/0012672 A1
(43) Pub. Date: Jan. 9, 2014

(54) CONTENT-BASED BIDDING IN ONLINE ADVERTISING

(71) Applicants: Jun Ye, Palo Alto, CA (US); Yu Cao, Saratoga, CA (US); Luoqi Chen, Saratoga, CA (US); Ya Luo, Milpitas, CA (US); Wei Zhuang, Palo Alto, CA (US); Hanying Feng, Fremont, CA (US); Hong Chen, San Jose, CA (US)

(72) Inventors: Jun Ye, Palo Alto, CA (US); Yu Cao, Saratoga, CA (US); Luoqi Chen, Saratoga, CA (US); Ya Luo, Milpitas, CA (US); Wei Zhuang, Palo Alto, CA (US); Hanying Feng, Fremont, CA (US); Hong Chen, San Jose, CA (US)

(21) Appl. No.: 13/543,708

(22) Filed: Jul. 6, 2012

(51) Int. Cl. G06Q 30/02

(52) U.S. Cl. 705/14.54; 705/14.49

(57) ABSTRACT

A method of providing targeted online advertisement includes receiving a request for an ad impression. The request includes a first content and a second content. The method also includes determining information related to (i) a context of the first content, (ii) a context of the second content, and (iii) a correlation between the context of the first content and the context of the second content, and providing the determined information to a bidding service, thereby enabling one or more advertisers to place one or more bids on the ad impression based on the provided information. Each of the one or more bids includes a bid price. The method further includes receiving the one or more bids for the ad impression, selecting one of the one or more received bids based at least in part on the bid prices, and providing an ad impression associated with the selected bid.

The following two regular U.S. patent applications (including this one) are being filed concurrently, and the entire disclosure of the other application is incorporated by reference into this application for all purposes:

Application Ser. No. ______, filed Jul. 6, 2012, entitled “Content-Based Targeted Online Advertisement” (Attorney Docket No. 93463-830757(000300US) and

Application Ser. No. ______, filed Jul. 6, 2012, entitled “Content-Based Bidding in Online Advertising” (Attorney Docket No. 93463-845842(000310US).

### BACKGROUND OF THE INVENTION

The increasing popularity of computers and use of communication networks such as the Internet has revolutionized the manner in which advertisers and vendors advertise products and services. Communication networks such as the Internet provide the opportunity for advertisers to reach a wide audience of potential customers. For example, search engines such as Baidu.com, web portal services such as Sina.com, and affiliate programs provide advertisers the opportunity to place ads on their webpages. The ads may comprise hyperlinks (e.g., URLs) to vendors' websites. The effectiveness of an ad campaign may be measured by click-through rate, i.e., the rate online users click on the ad and complete an action. To achieve a click-through, an ad may advantageously be chosen such that the content of the ad is relevant to the user's interest. For example, when a user is reading a webpage about a certain vacation destination, an ad about travel packages to that vacation destination might be of interest to the user, and thus is more likely to be clicked by the user. Online advertising can be targeted to internet users in many different ways in order to reach the advertiser's most relevant audience. For example, contextual-targeting and semantic-targeting are widely used in display advertisement. A contextual-targeting system scans the content of a webpage for keywords and returns an advertisement based on the keywords. A semantic-targeting system applies semantic analysis techniques to interpret and identify the topic of a webpage and returns an advertisement that matches the topic. Currently, most contextual-targeting and semantic-targeting methods consider only the content of the current webpage with which the advertisement is to be displayed.

Therefore, a heretofore unaddressed need exists in the art to address at least the aforementioned deficiencies and inadequacies.

### SUMMARY OF THE INVENTION

The present invention relates generally to systems and methods of providing advertising in a network environment. More particularly, embodiments of the present invention provide systems and methods of providing content-based targeted advertising using various targeting approaches.

According to an embodiment of the present invention, a method of providing targeted online advertisement includes receiving a request for an ad impression to be provided to a user in a network environment. The request includes a first content and a second content. The method also includes determining a context of the first content and a context of the second content, determining a correlation between the context of the first content and the context of the second content, and identifying a plurality of ads as candidates for consideration. The method further includes ranking the plurality of identified ads, selecting an ad among the plurality of identified ads based at least in part on a result of the ranking, and providing the selected ad as the ad impression to be displayed to the user in response to receiving the request.

According to another embodiment of the present invention, a system for providing targeted online advertisement includes a processor and at least one memory device. The memory device stores instructions that, when executed by the processor, cause the system to receive a request for an ad impression to be provided to a user in a network environment. The request includes a first content and a second content. The instructions also cause the system to determine a context of the first content and a context of the second content, determine a correlation between the context of the first content and the context of the second content, and identify a plurality of ads as candidates for consideration. The instructions further cause the system to rank the plurality of identified ads, select an ad among the plurality of identified ads based at least in part on a result of the ranking, and provide the selected ad as the ad impression to be displayed to the user in response to receiving the request.

According to a further embodiment of the present invention, a non-transitory computer-readable storage medium includes instructions for providing targeted online advertisement. The instructions when executing cause at least one computer system to receive a request for an ad impression to be provided to a user in a network environment. The request includes a first content and a second content. The instructions also cause the at least one computer system to determine a context of the first content and a context of the second content, determine a correlation between the context of the first content and the context of the second content, and identify a plurality of ads as candidates for consideration. The instructions further cause the at least one computer system to rank the plurality of identified ads, select an ad among the plurality of identified ads based at least in part on a result of the ranking, and provide the selected ad as the ad impression to be displayed to the user in response to receiving the request.

According to a specific embodiment of the present invention, a method of providing targeted online advertisement includes receiving a request for an ad impression. The request includes a first content and a second content. The method also includes determining information related to (i) a context of the first content, (ii) a context of the second content, and (iii) a correlation between the context of the first content and the context of the second content, and providing the determined information to a bidding service, thereby enabling one or more advertisers to place one or more bids on the ad impression based on the provided information. Each of the one or more bids includes a bid price. The method further includes receiving the one or more bids for the ad impression, selecting one of the one or more received bids based at least in part on the bid prices, and providing an ad impression associated with the selected bid.

According to another specific embodiment of the present invention, a system for providing targeted online advertisement includes a processor and at least one memory device. The memory device stores instructions that, when executed by the processor, cause the system to receive a request for an ad impression. The request includes a first content and a second content. The instructions also cause the system to determine information related to (i) a context of the first content, (ii) a context of the second content, and (iii) a correlation between the context of the first content and the context of the second content, and provide the determined information to a bidding service, thereby enabling one or more advertisers to place one or more bids on the ad impression based on the provided information. Each of the one or more bids includes a bid price. The instructions further cause the system to receive the one or more bids for the ad impression, select one of the one or more received bids based at least in part on the bid prices, and provide an ad impression associated with the selected bid.

According to further specific embodiment of the present invention, a non-transitory computer-readable storage medium includes instructions for providing targeted online advertisement. The instructions when executing cause at least one computer system to receive a request for an ad impression to be provided to a user in a network environment. The request includes a first content and a second content. The instructions also cause the at least one computer system to determine information related to (i) a context of the first content, (ii) a context of the second content, and (iii) a correlation between the context of the first content and the context of the second content, and provide the determined information to a bidding service, thereby enabling one or more advertisers to place one or more bids on the ad impression based on the provided information. Each of the one or more bids includes a bid price. The instructions further cause the at least one computer system to receive the one or more bids for the ad impression, select one of the one or more received bids based at least in part on the bid prices, and provide an ad impression associated with the selected bid.

According to various embodiments of the present invention, by considering both the context of the current webpage and the context of previous webpage(s), more effective targeting in display ads may be achieved. Increased monetization of the more effectively targeted ads may be captured through real-time bidding.

These and other aspects of the present disclosure will become apparent from the following description of various embodiments taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments and together with the written description, serve to explain various principles of the invention. Wherever possible, the same reference numbers are used throughout the drawings to refer to the same or like elements of an embodiment, and wherein:

FIG. 1 illustrates a method of selecting an ad to be displayed with a web content according to one embodiment;

FIG. 2 illustrates a method of selecting an ad to be displayed with a web content according to another embodiment;

FIG. 3 illustrates a method of selecting an ad to be displayed with a web content according to yet another embodiment;

FIG. 4 is a simplified flowchart illustrating a method of providing targeted online advertisement according to one embodiment;

FIG. 5 is a simplified flowchart illustrating a method of providing online advertisement according to one embodiment; and

FIG. 6 is a simplified schematic diagram of a network environment that may incorporate various embodiments.

### DETAILED DESCRIPTION OF SPECIFIC EMBODIMENTS

Various embodiments will now be described more fully hereinafter with reference to the accompanying drawings, in which exemplary embodiments are shown. Various aspects may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

One of the benefits of online advertising is that it allows for customization of advertisements. Search advertising is a method of placing online advertisements on webpages that show search results in response to search queries entered on search engines. Search ads, often referred to as sponsored ads, are targeted to keywords of the search queries. Search ads can be extremely relevant to users' interests because of their search intentions. On the other hand, display ads appears on webpages provided by website publishers. Display ads may be targeted to internet users in many different ways in order to reach the advertiser's most relevant audience. Contextual-targeting and semantic-targeting are two such targeting methods widely used in display ads. A contextual-targeting system scans the content of a webpage for keywords and returns an ad based on the keywords. A semantic-targeting system applies semantic analysis techniques to interpret and identify the topic of a webpage and returns an ad based on the topic. Instead of scanning a webpage for keywords, a semantic-targeting system examines all the words and identifies the senses of those words. Semantic-targeting may also be capable of identifying the sentiment of a webpage through analysis of the language used on the webpage. Sentiment analysis can determine whether a content has a positive or negative sentiment toward a topic. If the content is being detrimental about a particular subject, the semantic-targeting system could deter the placement of a related ad alongside the content.

Commonly assigned U.S. patent application Ser. No. 13/230,720, filed on Sep. 12, 2011, describes methods of sentiment-targeting for online advertisement and is hereby incorporated by reference in its entirety for all purposes. Commonly assigned U.S. patent application Ser. No. 13/209,256, filed on Aug. 12, 2011, describes methods of attention-targeting for online advertisement and is hereby incorporated by reference in its entirety for all purposes.

Currently, most contextual-targeting and semantic-targeting methods consider only the content of the current webpage with which the advertisement is to be displayed. Since the content of the webpage(s) displayed to the same user immediately or shortly prior to the current webpage may provide additional targeting information, an advertisement system may advantageously take into consideration both the content of the present webpage and the content of the previous webpage(s). The advantages of such an advertisement system may be particularly significant if there is a strong correlation between the content of the current webpage and the content of the previous webpage(s).

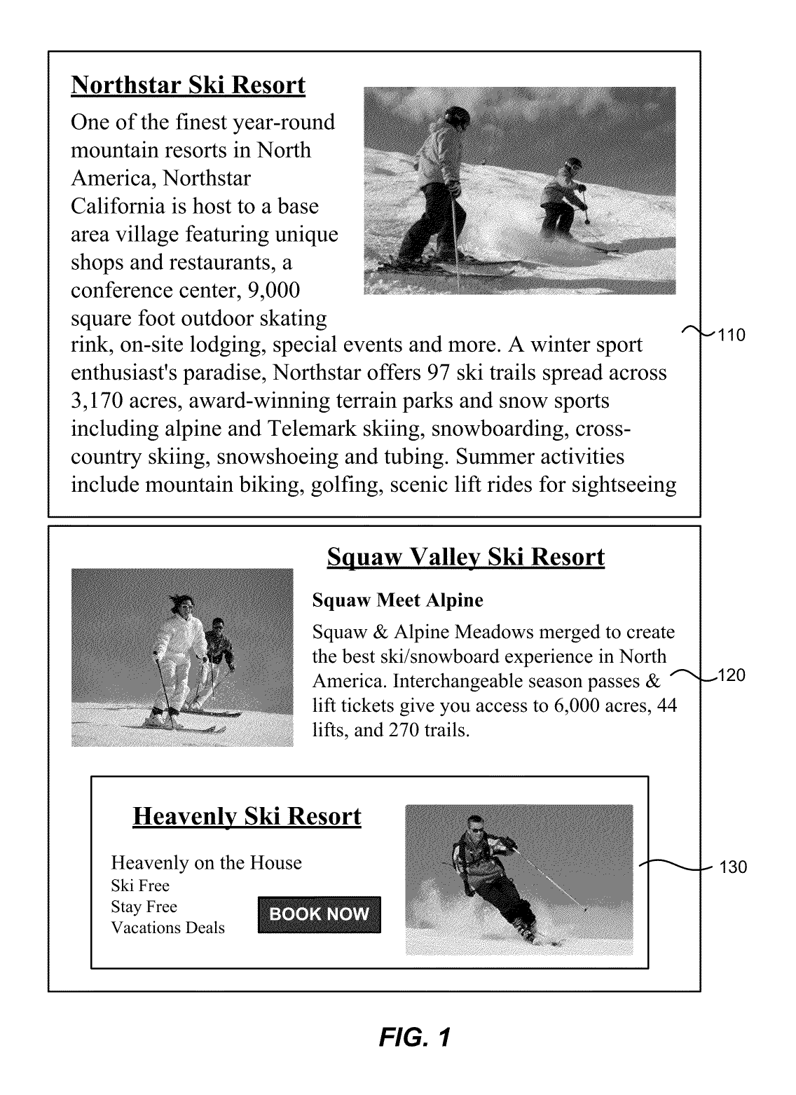

FIG. 1 illustrates an example where an ad 130 may be advantageously chosen for display with a current webpage 120 based on both the content of the current webpage 120 and the content of a previous webpage 110 that was displayed to the user just before the current webpage 120. In this illustrative example, the current webpage 110 is about a ski resort in Lake Tahoe; and the previous webpage 120 is about another ski resort in Lake Tahoe. The fact that the user is viewing two webpages on the same topic consecutively (or within a short period of time) suggests that the user has an imminent interest in the topic. Furthermore, the fact that the user is viewing information about two different ski resorts in the same geographical area suggests that the user is comparing the two ski resorts, perhaps trying to decide which one to go for an upcoming ski trip. Thus, an ad 130 about a third ski resort in the same geographical area may be advantageously displayed to the user alongside the current webpage 120, as the user is more likely to click on it or even make a purchase. In comparison, a conventional advertisement system that considers only the content of the current webpage 120 may very well choose an ad about ski equipment, which might be less relevant to the user's interest.

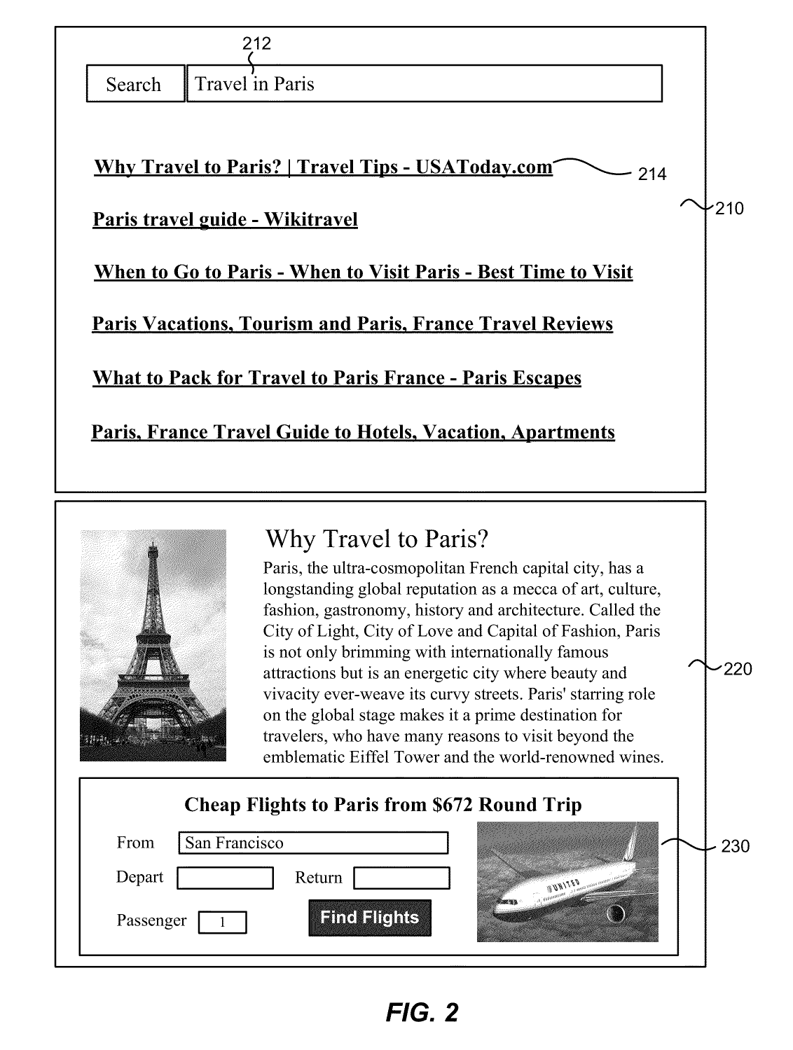

FIG. 2 illustrates another example of a content-based targeting method according to an embodiment. In this example, the previous webpage 210 is a search result page. The search result page includes a search query 212 (e.g., the phrase “Travel in Paris”) entered by the user and a plurality of search results 214 generated by a search engine in response to the search query 212. The user is lead to the current webpage 220 by selecting one of the search results 214 displayed on the search result page. The fact that the user is actively searching about a topic suggests that the user has a genuine interest in the topic. Therefore, an ad 230 that matches the keywords of the search query 214 (e.g., an ad about cheap airfares to Paris) may be advantageously displayed alongside the current webpage 220. In general, search ads are more valuable than display ads in terms of revenue potential because of their high relevance to users' interests. Therefore, in this example, the value of the ad impression may be as high as that of a search ad. In fact, the value of the display ad may be even higher than that of a search ad, since the user has taken the extra step of click on the particular search result. According to embodiments of the invention, such increased value may be captured through a real-time bidding system.

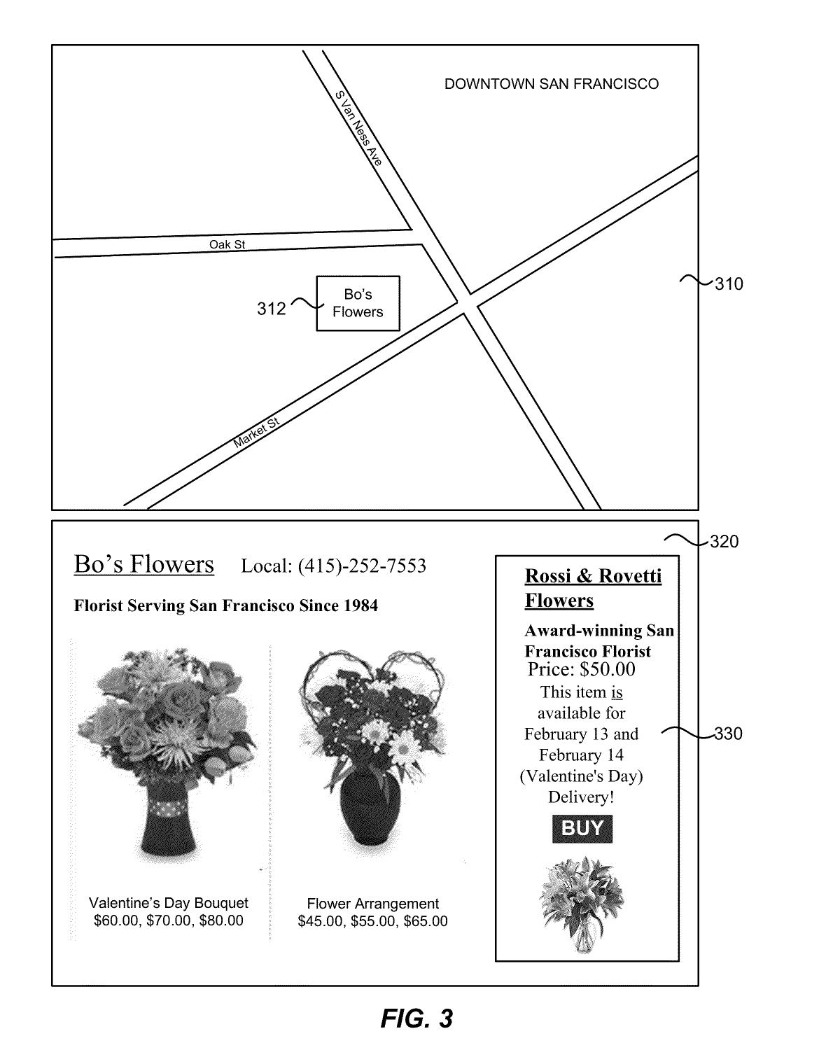

FIG. 3 illustrates yet another example of a content-based targeting method according to an embodiment. In this example, the previous webpage 310 is an online map that includes the location of a business (e.g., Bo's Flowers), and the current page 320 is a webpage about the business. The user might be lead to the current webpage 320 by selecting a link provided on the map or by other means. The fact that the user is viewing information about a business located on a map suggests that the user is actively looking for information related to the business (e.g., flowers) in the geographic area of the map. Therefore, an ad 330 about another business in the same category (e.g., Rossi & Rovetti Flowers) in the vicinity of the geographic area may be advantageously displayed alongside the current webpage. The same concept may apply to a situation where the current and previous webpages are in reverse order, that is, the current web is a map and the previous webpage is a business located on the map.

It should be appreciated that the present invention is not limited to these particular embodiments. Other types of webpage combinations may also be exploited to provide targeted online advertisement according to various embodiments. It should also be appreciated that the previous webpage does not have to be the webpage shown to the user immediately prior to the current webpage. It may be a webpage shown to the user within a certain time frame (e.g., 5 minutes) before the current page. In yet other embodiments, contents of more than two webpages may be considered. One of ordinary skill in the art would recognize many variations, modifications, and alternatives.

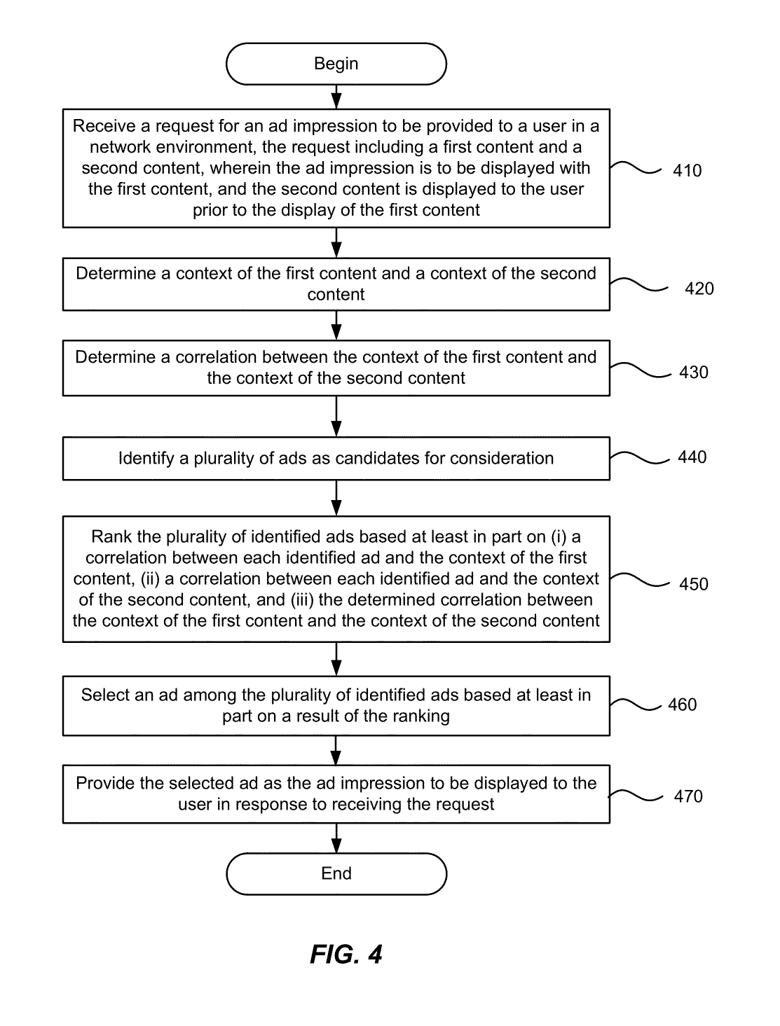

The present disclosure, in one aspect, relates to systems and methods of providing targeted online advertisement that takes into consideration both the content of the current webpage and the content of the previous webpage(s). FIG. 4 is a simplified flowchart illustrating a method 400 of targeted online advertisement according to one embodiment. The method 400 includes receiving a request for an ad impression to be provided to a user in a network environment (410). The request includes a first content (e.g., the content of a current webpage) with which the ad is to be displayed. The request also includes a second content that is displayed to the user prior to the display of the first content (e.g., the content of a previous webpage). The method 400 further includes determining a context of the first content and a context of the second content (420). The method 400 further includes determining a correlation between the context of the first content and the context of the second content (430).

According to an embodiment, the method 400 further includes identifying a plurality of ads as candidates for consideration (440), using any appropriate techniques known or used in the art for such purposes. Such techniques may be based on, for example and without limitation, ontology (computer science) and/or taxonomy. The method 400 further includes ranking the plurality of identified ads based at least in part on (i) a correlation between each identified ad and the context of the first content, (ii) a correlation between each identified ad and the context of the second content, and (iii) the determined correlation between the context of the first content and the context of the second content (450). The method 400 further includes selecting an ad among the plurality of identified ads based at least in part on a result of the ranking (460), and providing the selected ad as the ad impression to be displayed to the user in response to receiving the request (470).

It should be appreciated that the specific steps illustrated in FIG. 4 provide a particular method of targeted online advertisement according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

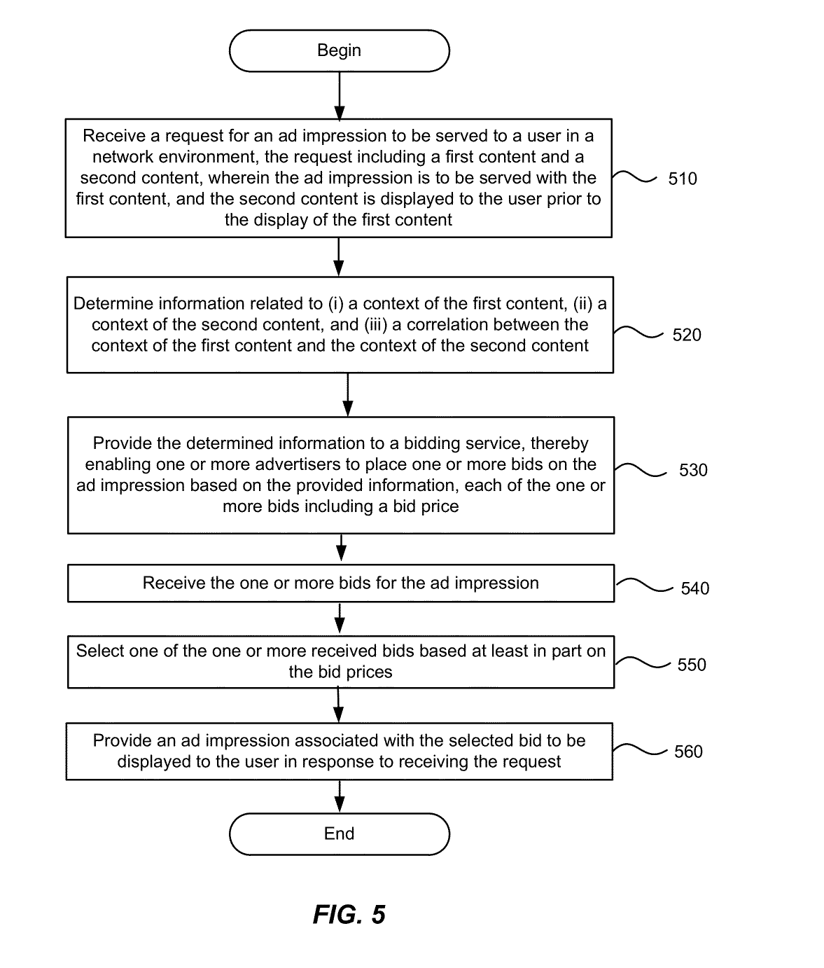

FIG. 5 is a simplified flowchart illustrating a method 500 of targeted online advertisement according to another embodiment. The method 500 includes receiving a request for an ad impression to be provided to a user in a network environment (510). The request includes a first content with which the ad is to be displayed. The request also includes a second content that is displayed to the user prior to the display of the first content. The method 500 further includes determining information related to (i) a context of the first content, (ii) a context of the second content, and (iii) a correlation between the context of the first content and the context of the second content (520). The method 500 further includes providing the determined information to a bidding service, thereby enabling one or more advertisers to place one or more bids on the ad impression based on the provided information (530). Each of the one or more bids includes a bid price. The method 500 further includes receiving the one or more bids for the ad impression (540), and selecting one of the one or more received bids based at least in part on the bid prices (550). The method 500 further includes providing an ad impression associated with the selected bid to be displayed to the user in response to receiving the request (560).

It should be appreciated that the specific steps illustrated in FIG. 5 provide a particular method of targeted online advertisement according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

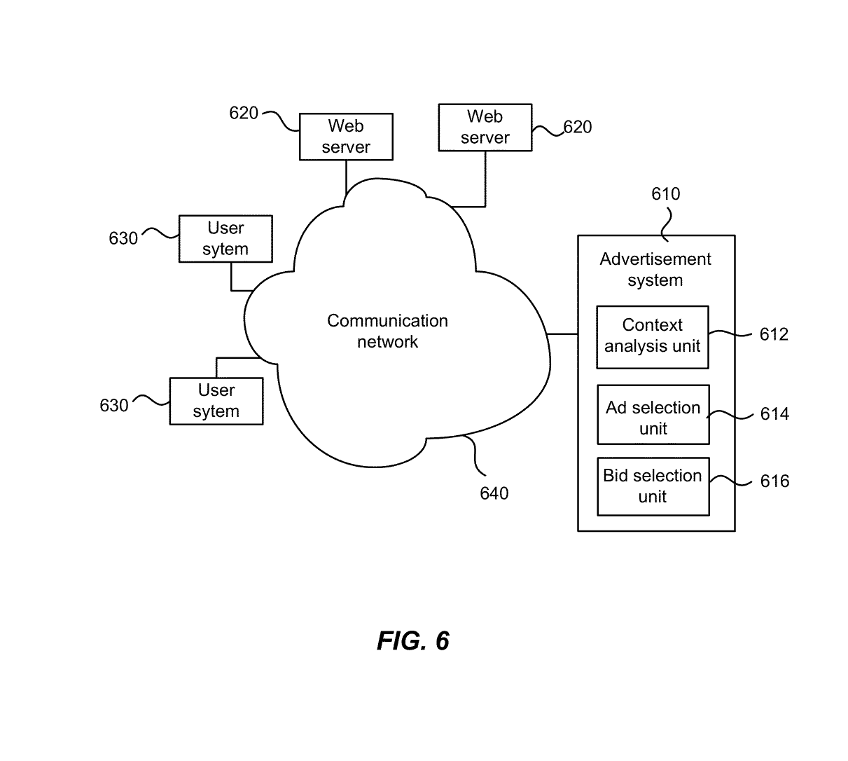

FIG. 6 shows a schematic diagram of an example network environment that may incorporate an embodiment of the present invention. The advertisement system 610 is interconnected with one or more web servers 620 and one or more user systems 630 via a communication network 640. The advertisement system 610 comprises a context analysis unit 612 and an ad selection unit 614. In one embodiment, the advertisement system 610 receives a request for an ad to be provided to a user. The request includes a first content with which the ad is to be displayed. The request also includes a second content that is displayed to the user prior to the display of the first content. The context analysis unit 612 determines a context of the first content and a context of the second content. The context analysis unit 612 then determines a correlation between the context of the first content and the context of the second content.

According to an embodiment, the advertisement system 610 stores a collection of ads that may be used for display in response to receiving a request. The ad selection unit 614 identifies a plurality of ads from the collection of ads stored in the system as candidate for consideration using any appropriate techniques known or used in the art for such purposes. In one embodiment, the ad selection unit 614 ranks the plurality of identified ads based at least in part on (i) a correlation between each identified ad and the context of the first content, (ii) a correlation between each identified ad and the context of the second content, and (iii) the determined correlation between the context of the first content and the context of the second content. The ad selection unit 614 then selects an ad among the plurality of identified ads based at least in part on a result of the ranking. The advertisement system 610 then provides the selected ad to be displayed to the user in response to receiving the request.

According to an embodiment, the advertisement system 610 further comprises a bid selection unit 616. The advertisement system 610 provides information related to (i) the context of the first content, (ii) the context of the second content, and (iii) the correlation between the context of the first content and the context of the second content to a bidding serve, thereby enabling one or more advertisers to place one or more bids on the ad impression based on the provided information. Each of the one or more bids includes a bid price. The advertisement system 610 receives the one or more bids for the ad impression. The bid selection unit 616 then selects one of the one or more received bids based at least in part on the bid prices. In one embodiment, the advertisement system 610 provides an ad impression associated with the selected bid to be displayed to the user in response to receiving the request.

According to alternative embodiments, the advertisement system 610 may include additional, fewer, and/or different configuration of the components shown in FIG. 6. One of ordinary skill in the art would recognize many variations, modifications, and alternatives.

Communication network 640 provides a mechanism for allowing communication between the various systems depicted in FIG. 6. Communication network 640 may be a local area network (LAN), a wide area network (WAN), a wireless network, an Intranet, the Internet, a private network, a public network, a switched network, or any other suitable communication network. Communication network 640 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), protocols under development by industry standard organizations, vendor-specific protocols, customized protocols, and others.

User systems 630 can be of various types including a personal computer, a portable computer, a workstation, a network computer, a mainframe, a smart phone, a personal digital assistant (PDA), a kiosk, or any other data processing system.

The advertisement system 610 may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention. The computer comprises a microprocessor, a communication bus, and a memory. The memory may include Random Access Memory (RAM) and Read Only Memory (ROM). Further, the computer system comprises a storage device, which can be a hard disk drive, a solid state drive based on flash memory device, or a removable storage drive such as a floppy disk drive, an optical disk drive, and the like. The storage device can also be other similar means for loading computer programs or other instructions into the computer system.

The computer system executes a set of instructions that are stored in one or more storage elements, to process input data. The storage elements may also hold data or other information, as desired. The storage elements may be an information source or physical memory element present in the processing machine. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module within a larger program, or a portion of a program module. The software might also include modular programming in the form of object-oriented programming. Processing of input data by the processing machine may be in response to user commands, to the results of previous processing, or to a request made by another processing machine.

Aspects of the present invention can be stored as program code in hardware and/or software. Storage media and non-transitory computer readable media for containing code, or portions of code, for implementing aspects and embodiments of the present invention can include, for example and without limitation, magnetic disk drive, solid state drive, flash memory, magnetic tapes, floppy disks, optical disks, CD-ROMs, digital versatile disk (DVD), magnetic-optical disks, read-only memories (ROMs), random access memories (RAMs), erasable programmable ROMs (EPROMs), and electrically erasable programmable ROMs (EEPROMs).

In the following various targeting algorithms are described according to various embodiments.

Context Vectors

According to various embodiments, the advertisement system receives a request for an ad impression to be provided to a user in a network environment. The request includes a first content with which the ad is to be displayed. The request also includes a second content that is displayed to the user prior to the display of the first content. Each of the first content and the second content may include, for example and without limitation, a news article, a search result page including one or more search words, a map, a webpage of a business, a piece of music, or a video clip. In response to receiving the request, the advertisement system analyzes the context of the first content and the context of the second content using various contextual and semantic analysis algorithms as known in the art. Such algorithms may include, for example and without limitation, keywords matching, language-independent proximity pattern matching, natural language processing, computational linguistics, and the like.

According to various embodiments, the advertisement system determines a context vector for each of the first content and the second content, C1 and C2, respectively, according to the results of the contextual and semantic analyses. Each of C1 and C2 is an N-dimensional vector. Each of the N dimensions corresponds to a category (i.e., a node) in a taxonomy classification of topics. Exemplary categories may include science, sport, art, travel, food, cars, geographic locations, and the like. According to embodiments, there may be as many as thousands of categories in the classification to cover most possible topics. Each component of the C1 or C2 vector is a continuous value between zero and one, which indicates a relative degree of relevance of the respective content to the respective category. For proper normalization, the sum of all components of each of C1 and C2 is normalized to one.

According to an embodiment, the advertisement system determines if the second content is a search page. If it is determined that the second content is a search page, the advertisement system then determines the keywords in the search query entered on the search engine and determines the context vector C2 based at least in part on the determined keywords. According to an embodiment, the advertisement system also determines if either of the first content and the second content is a map. If it is determined that either of the first content and the second content is a map, the advertisement system then determines a geographic location shown in the map and determines the context vector C1 or C2 based at least in part on the determined geographic location. It should be appreciated that the present invention is not limited to these particular embodiments. The advertisement system may determine other types of webpage characteristics and determine the context vectors accordingly. One of ordinary skill in the art would recognize many variations, modifications, and alternatives.

According to an embodiment, the advertisement system determines the context vectors C1 and C2 in real time during ad serving. That is, in response to receiving a request for providing an ad, the system analyzes the context of the first content and the context of the second content, and determines the context vectors C1 and C2 accordingly. According to an alternative embodiment, the system determines context vectors C1 and C2 in quasi-real time. That is, when a content is included in a request for the first time, the system analyzes its context and determines a context vector for the content. The system then stores the context vector for future use when the same content (e.g., its URL) appears in another request. In yet another embodiment, the system proactively crawls web contents that the system may serve ads in. The corresponding context vectors are determined and saved in the system ahead of time. Latency delay in ad serving may be reduced in the latter two embodiments.

Ad Relevance Vector

According to various embodiments, the advertisement system stores a collection of ads that may be used for display in response to receiving a request. Each ad is assigned an N-dimensional ad relevance vector R. Each component of the R vector is a continuous value between zero and one, which indicates a relative degree of relevance of the ad to the respective category of topics. In one embodiment, the component corresponding to the most relevant category is assigned a value of 1.0. The R vectors may be determined by advertisers, ad designers, ad experts, and the like. Alternatively, the R vectors may be determined automatically using various contextual and semantic analysis algorithms known in the art.

Ad Content-Targeting Score

According to various embodiments, in response to receiving a request for providing an ad impression, the advertisement system identifies a plurality of ads from the collection of ads stored in the system as candidates for consideration. The advertisement system then determines an ad content-targeting score CS for each of the plurality of identified ads. In one embodiment, the ad content-targeting score CS is determined according to the following equation,

CS=α₁·R•C1+α₂·R•C2+α₃·F(C1═C2),

where the symbol “•” denotes the inner-product of two vectors, F(C1•C2) is a predetermined function of C1•C2, and α₁, α₂, and α₃ are predetermined weighting coefficients for each of the three terms in the equation, respectively.

The first term in the above equation indicates the correlation between the ad and the context of the first content. The second term indicates the correlation between the ad and the context of the second content. The third term depends on the correlation between the context of the first content and the context of the second content. According to embodiments, F(C1•C2) may be determined by the equation,

F(C1•C2)=(C1•C2)ⁿ,

where n is a positive integer. According to alternative embodiments, F(C1•C2) may be other functions of C1•C2, such as exponential function, logarithmic function, or the like.

F(C1•C2) may also be replaced by a more general function F(C1,C2), that measures the correlation between the two distributions of C1 and C2, for example, Jensen-Shannon divergence. It should also be appreciated that other algorithms may be used to determine a correlation between the context of the first content and the context of the second content. For example, a correlation function F(C1,C2) (here C1 and C2 denote context of the first content and the context of the second content, respectively, and are not necessarily the context vectors as defined above) may be assigned a value according to various types of webpage combinations using machine learning algorithms. One of ordinary skill in the art would recognize many variations, modifications, and alternatives.

According to some embodiments, the ad content-targeting score CS may be used as a part of an overall ad targeting score for the ad,

AdScore=β·CS+(1−β)·Sₒₜₕₑᵣ,

where AdScore is the overall ad targeting score, CS is the content-targeting score, Sₒₜₕₑᵣ is a targeting score for all non-content-related targeting, such as behavior-targeting, demographic-targeting, etc., and β and (1−β) are predetermined weighting coefficients assigned to content-targeting and non-content-related targeting, respectively.

Ad Selection

In one embodiment, after the system has determined the ad-targeting scores for the plurality of identified ads, the system selects an ad among the plurality of identified ads based at least in part on the determined ad-targeting scores. In one embodiment, the system selects an ad that has the highest ad-targeting score among the plurality of ads. In other embodiments, the system selects an ad based on a probability function that is proportional to the ad-targeting scores, or proportional to the n^{th} power of the ad-targeting scores.

It should be appreciated that the specific algorithms described above are merely examples for illustrative purposes. Other algorithms, such as various machine learning algorithms may also be used to provide targeted advertisement based on the webpage combinations. One of ordinary skill in the art would recognize many variations, modifications, and alternatives.

Ad Monetization

As discussed above, a targeted ad impression based on the combination of current webpage and previous webpage(s) in accordance with embodiments of the present invention may be highly relevant to a user's interest. Therefore, such an ad impression may have a relatively high revenue potential since the user is likely to click on the ad or even make a purchase. According to various embodiments, the advertisement system may be configured to capture the higher values of such ad impressions through real-time ad bidding.

According to some embodiments, a mechanism may be built into a supply side platform (SSP) to differentiate ad monetization for different webpage combinations. For example, it is known that search ads are much more valuable than display ads. Therefore, according to an embodiment, if the system determines that the previous webpage is a search result page, the cost-per-click (CPC) or cost-per-impression (CPM) price for the corresponding ad impression may be set to be the same as a search ad. If a certain percentage of a webpage's views are referred from search pages, the average value of a display ad may be increased as a result of the search ad ripple effect. For example, assuming that the CPC price for a search ad is five (5) times that of an ordinary display ad, and that 5% of a webpage's views are referred from search pages, the average value of the display ad would be increased by 20%.

According to an embodiment, the advertisement system provides information related to (i) the context of the first content C1, (ii) the context of the second content C2, and (iii) the correlation between the context of the first content and the context of the second content F(C1,C2) to a real-time bidding system. Advertisers are thus enabled to place their bids based on the provided information. For example, an advertiser may place a higher bid on an ad impression when the value of F(C1,C2) is higher. According to embodiments, the advertisement system receives one or more bids from one or more advertisers, each bid including a bid price. The advertisement system selects one of the one or more received bids based at least in part on the bid prices. According to an embodiment, the advertisement system may select the highest bid. According to an alternative embodiment, the advertisement system may select a bid based on the bid price as well as other factors, such as the likelihood of the advertiser's ad being clicked. The advertisement system then serves an ad impression associated with the selected bid.

The foregoing description of the exemplary embodiments has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computer-implemented method of providing online advertisement, comprising:
providing a computer having a processor;
receiving a request for an ad impression to be served to a user in a network environment, the request including a first content and a second content, wherein the ad impression is to be served with the first content, and the second content is displayed to the user prior to the display of the first content;
determining, using the processor, information related to (i) a context of the first content, (ii) a context of the second content, and (iii) a correlation between the context of the first content and the context of the second content;
providing the determined information to a bidding service, thereby enabling one or more advertisers to place one or more bids on the ad impression based on the provided information, each of the one or more bids including a bid price;
receiving the one or more bids for the ad impression;
selecting, using the processor, one of the one or more received bids based at least in part on the bid prices; and
providing an ad impression associated with the selected bid to be displayed to the user in response to receiving the request.

2. The computer-implemented method of claim 1 wherein each bid price comprises a cost-per-impression price or a cost-per-click price.

3. The computer-implemented method of claim 1 wherein the second content is displayed to the user immediately prior to the display of the first content.

4. The computer-implemented method of claim 1 wherein the first content is to be displayed to the user as a result of the user navigating through the second content.

5. The computer-implemented method of claim 4 wherein the second content includes one or more search results displayed to the user in response to a search query submitted by the user, and the first content is to be displayed to the user as a result of the user selecting one of the one or more search results.

6. The computer-implemented method of claim 5 wherein determining the context of the second content includes determining one or more keywords of the search query submitted by the user.

7. The computer-implemented method of claim 1 wherein one of the first content and the second content includes a map showing locations of one or more businesses, and the other one of the first content and the second content is associated with one of the one or more businesses.

8. A system for providing online advertisement, comprising:
a processor; and
at least one memory device storing instructions that, when executed by the processor, cause the system to:
receive a request for an ad impression to be served to a user in a network environment, the request including a first content and a second content, wherein the ad impression is to be served with the first content, and the second content is displayed to the user prior to the display of the first content;
determine information related to (i) a context of the first content, (ii) a context of the second content, and (iii) a correlation between the context of the first content and the context of the second content;
provide the determined information to a bidding service, thereby enabling one or more advertisers to place one or more bids on the ad impression based on the provided information, each of the one or more bids including a bid price;
receive the one or more bids for the ad impression;
select one of the one or more received bids based at least in part on the bid prices; and
provide an ad impression associated with the selected bid to be displayed to the user in response to receiving the request.

9. The system of claim 8 wherein each bid price comprises a cost-per-impression price or a cost-per-click price.

10. The system of claim 8 wherein the second content is displayed to the user immediately prior to the display of the first content.

11. The system of claim 8 wherein the first content is to be displayed to the user as a result of the user navigating through the second content.

12. The system of claim 11 wherein the second content includes one or more search results displayed to the user in response to a search query submitted by the user, and the first content is to be displayed to the user as a result of the user selecting one of the one or more search results.

13. The system of claim 12 wherein determining the context of the second content includes determining one or more keywords of the search query submitted by the user.

14. The system of claim 8 wherein one of the first content and the second content includes a map showing locations of one or more businesses, and the other one of the first content and the second content is associated with one of the one or more businesses.

15. A non-transitory computer-readable storage medium comprising a plurality of computer-readable instructions tangibly embodied on the computer-readable storage medium, which, when executed by a data processor, provide targeted online advertisement, the plurality of instructions comprising:
instructions that cause the data processor to receive a request for an ad impression to be served to a user in a network environment, the request including a first content and a second content, wherein the ad impression is to be served with the first content, and the second content is displayed to the user prior to the display of the first content;
instructions that cause the data processor to determine information related to (i) a context of the first content, (ii) a context of the second content, and (iii) a correlation between the context of the first content and the context of the second content;
instructions that cause the data processor to provide the determined information to a bidding service, thereby enabling one or more advertisers to place one or more bids on the ad impression based on the provided information, each of the one or more bids including a bid price;
instructions that cause the data processor to receive the one or more bids for the ad impression;
instructions that cause the data processor to select one of the one or more received bids based at least in part on the bid prices; and
instructions that cause the data processor to provide an ad impression associated with the selected bid to be displayed to the user in response to receiving the request.

16. The non-transitory computer-readable storage medium of claim 15 wherein each bid price comprises a cost-per-impression price or a cost-per-click price.

17. The non-transitory computer-readable storage medium of claim 15 wherein the second content is displayed to the user immediately prior to the display of the first content.

18. The non-transitory computer-readable storage medium of claim 15 wherein the first content is to be displayed to the user as a result of the user navigating through the second content.

19. The non-transitory computer-readable storage medium of claim 18 the second content includes one or more search results displayed to the user in response to a search query submitted by the user, and the first content is to be displayed to the user as a result of the user selecting one of the one or more search results.

20. The non-transitory computer-readable storage medium of claim 15 wherein one of the first content and the second content includes a map showing locations of one or more businesses, and the other one of the first content and the second content is associated with one of the one or more businesses.
